(19) United States
(12) Patent Application Publication
(10) Pub. No.: US 2012/0266394 A1
(43) Pub. Date: Oct. 25, 2012

(54) LINEAR RECIPROCATING-TYPE DRIVING STRUCTURE AND A CLEANING TOOL

(75) Inventors: Ruiyu HE, (US); Weilin Hu, (US)

(73) Assignee: TRULY INSTRUMENT LIMITED, Shanwei City (CN)

(21) Appl. No.: 13/423,444

(22) Filed: Mar. 19, 2012

(30) Foreign Application Priority Data
Mar. 17, 2011 (CN) 201120070386.5

(51) Int. Cl. B08B 13/00; F16H 21/28; B08B 1/00

(52) U.S. Cl. 15/4; 15/3; 74/44

(57) ABSTRACT

The utility model relates to the technical field of driving structure, and provides a linear reciprocatingly movement-type driving structure and a cleaning tool. The linear reciprocatingly movement-type driving structure comprises of: a driving gear and a crown gear engaged with said driving gear; an eccentric cam that is set eccentrically on the crown gear, a first connecting shaft is set on said eccentric cam, a crankshaft is sleeved on the said first connecting shaft, while the crankshaft is connected to an output shaft. In the utility model, the driving method of the motor 16 could be changed from a 360-degree rotation into a linear reciprocating motion through the driving gear, the crown gear, the eccentric cam, the first connecting shaft, the crankshaft and the output shaft. Therefore the wear and tear is reduced and the service life is prolonged.

### CROSS-REFERENCE TO RELATED APPLICATIONS

This application is based upon and claims the benefit of priority of the prior Chinese Patent Application No. 201120070386.5, filed on Mar. 17, 2011, the entire contents of which are incorporated by reference herein.

### DESCRIPTION

1. Field of the Invention

The utility model relates to the technical field of driving structure, especially a linear reciprocatingly movement-type driving structure and a cleaning tool. This

2. Background of the Invention

Nowadays, the usual products of cleaning brushes usually takes a linear reciprocatingly movement-type driving structure that is driven by 360 degrees rotation. However, this driving method can easily cause the parts worn out and shorten the service life of the products.

Therefore, the existing driving structure in the prior art can easily cause the parts worn out and shorten the service life of the products.

### SUMMARY OF THE INVENTION

The object of the invention is to provide a linear reciprocatingly movement-type driving structure and solve the problems that the existing driving structure in the prior art can easily cause the parts worn out and shorten the service life of the products.

The utility model is materialized by a linear reciprocatingly movement-type driving structure, comprising of:

a driving gear and a crown gear engaged with said driving gear;

an eccentric cam that is set eccentrically on the crown gear, a first connecting shaft is set on said eccentric cam, a crankshaft is sleeved on the first connecting shaft, while the crankshaft is connected to an output shaft.

Preferred, the said linear reciprocating-type driving structure further comprises of:

a motor that causes the said driving gear to rotate.

Preferred, a ring is set on the crankshaft, and the said ring is sleeved on said first connecting shaft.

Preferred, said linear reciprocatingly movement-type driving structure further comprises of:

a upper casing and a lower casing that can be assembled together to form a housing;

the said motor, crown gear, crankshaft and output shaft are set inside the said housing.

The utility model also provides a cleaning tool, comprising of a casing, and said linear reciprocating-type driving structure is set inside said casing.

Preferred, said casing comprises a brushing head, while a scouring pad or hook-and-loop fastener is installed on the exterior part of the brushing head.

The benefit of the utility model comparing with the prior art is that: the driving method of the motor could be changed from a 360-degree rotation into a linear reciprocating motion through the driving gear, the crown gear, the eccentric cam, the first connecting shaft, the crankshaft and the output shaft. Therefore the wear and tear is reduced and the service life is prolonged.

### DESCRIPTION OF THE FIGURES

FIG. 1 is a schematic view of the linear reciprocatingly movement-type driving structure according to the utility model;

FIG. 2 is a decomposition schematic view of the linear reciprocatingly movement-type driving structure according to the utility model;

FIG. 3 is a schematic view that shows a first application of the linear reciprocatingly movement-type driving structure according to the utility model;

FIG. 4 is a schematic view that shows a second application of the linear reciprocatingly movement-type driving structure according to the utility model;

FIG. 5 is a schematic view that shows a third application of the linear reciprocatingly movement-type driving structure according to the utility model;

FIG. 6 is a schematic view that shows a fourth application of the linear reciprocatingly movement-type driving structure according to the utility model.

### PREFERRED EMBODIMENT OF THE INVENTION

The utility model will next be described in detail with reference to the figures and embodiments to clarify the object, the technical solution and the advantages of the utility model. It should be noted that the embodiments here are only for describing of the utility model, not for limiting the scope of this utility model.

The embodiment of the utility model is as the following:

A linear reciprocatingly movement-type driving structure, comprising of:

a driving gear and a crown gear engaged with said driving gear;

an eccentric cam that is set eccentrically on the crown gear, a first connecting shaft is set on said eccentric cam, a crankshaft is sleeved on the first connecting shaft, while the crankshaft is connected to an output shaft.

A cleaning tool, comprising a casing, and said linear reciprocating-type driving structure is set inside said casing.

In the utility model, the driving method of the motor could be changed from a 360-degree rotation into a linear reciprocating motion through the driving gear, the crown gear, the eccentric cam, the first connecting shaft, the crankshaft and the output shaft. Therefore the wear and tear is reduced and the service life is prolonged.

The application of the utility model will be explained in details with reference to the embodiments:

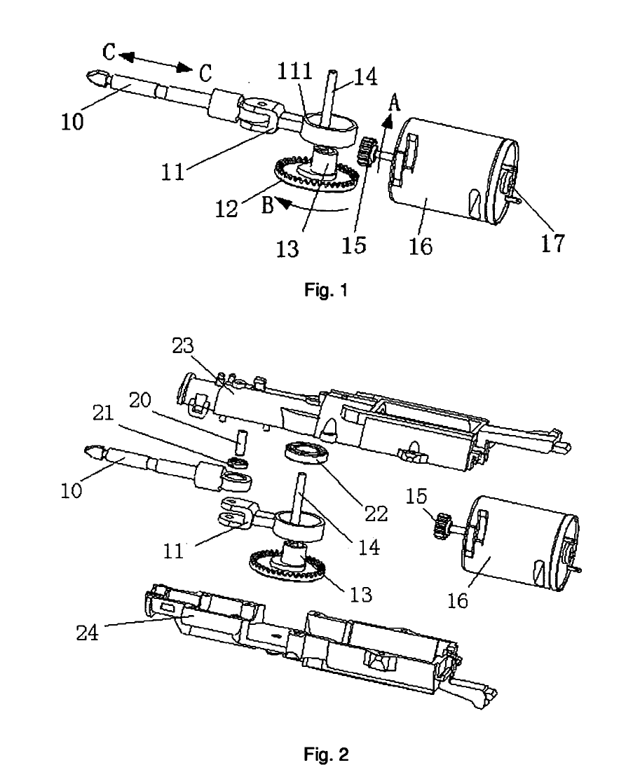

As shown in FIGS. 1 and 2, the utility model provides a linear reciprocatingly movement-type driving structure, comprising:

a driving gear 15 and a crown gear 12 engaged with said driving gear 15;

an eccentric cam 13 that is set eccentrically on the crown gear 12, a first connecting shaft 14 is set on said eccentric cam 13, a crankshaft 11 is sleeved on the first connecting shaft 14, while the crankshaft 11 is connected to a output shaft 10.

In an embodiment of the utility model, the connection between said crankshaft 11 and said output shaft 10 is materialized through a second connecting shaft 20 and a first cylindrical roller bearing 21.

In the application, the eccentricity of the eccentric cam 13 is adjusted according to the actual demand.

In an embodiment of the utility model, said linear reciprocating-type driving structure further comprises:

a motor 16 that causes the said driving gear 15 to rotate.

A battery 17 that provides electric is set on motor 16.

In the utility model, when the driving gear 15 rotates in direction A driven by motor 16, the driving gear 15 drives the crown gear 12 engaged on it to rotate in the direction B, which makes the first connecting shaft 14 that is set on the eccentric cam 13 to perform a circular motion. During the circular motion, the first connecting shaft 14 makes the crankshaft 11 perform a linear reciprocating motion in the direction of C-C, to further drives the output shaft 10 to do a linear reciprocating move in the direction of C-C. The output shaft 10 is connected to the driving components on the application end, therefore the driving is accomplished. In the utility model, the driving method of the motor 16 could be changed from a 360-degree rotation into a linear reciprocating motion through the linear reciprocatingly movement-type driving structure. Therefore the wear and tear is reduced and the service life is prolonged.

In the utility model, there is a ring 111 set on the crankshaft 11, and said ring 111 sleeves on said first connecting shaft 14.

In the utility model, said linear reciprocatingly movement-type driving structure further comprises:

a upper casing 23 and a lower casing 24 that can be assembled together to form a housing;

said motor 16, crown gear 13, crankshaft 11 and output shaft 10 are set inside the housing.

In the utility model, said bearing components further comprises of: a second cylindrical roller bearing 22 that is engaged with said first connecting shaft 14. Therefore, the frictional resistance generated during the rotation of the first connecting shaft 14 is reduced.

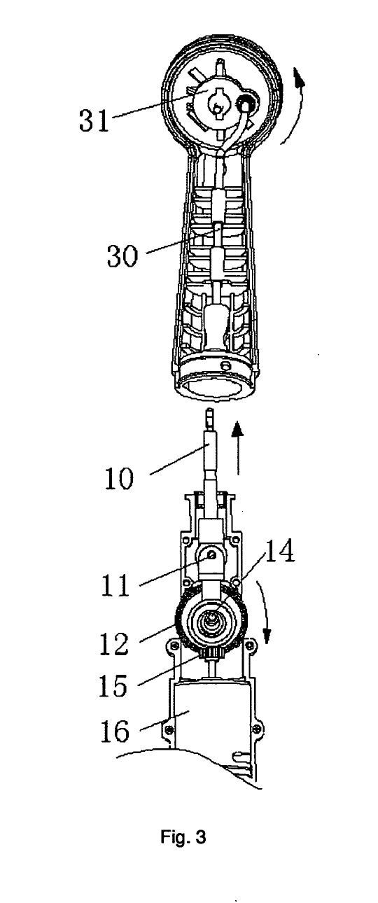

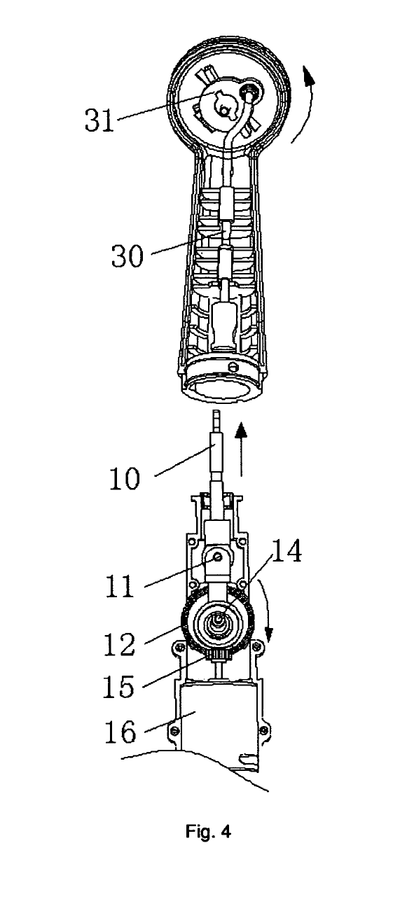

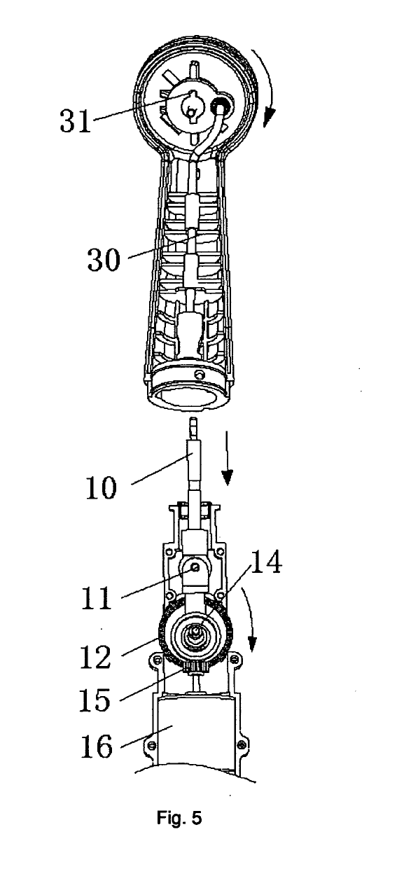

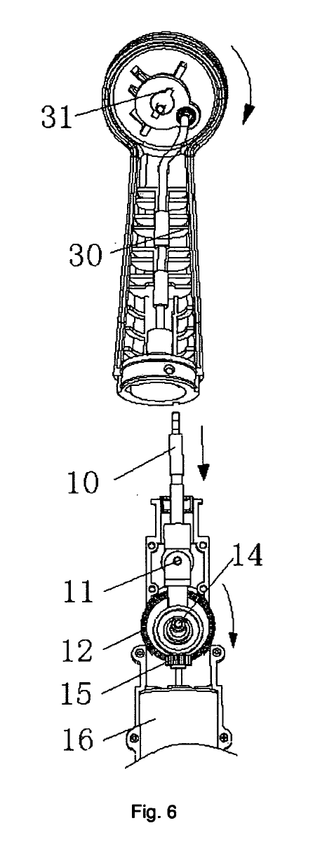

As shown in FIGS. 3, 4, 5 and 6, in the application, the linear reciprocatingly movement-type driving structure according to this utility model could be connected onto a cleaning tool, such as the drawbar shaft 30 of a cleaning brush. Said drawbar shaft 30 is connected to a driven part, such as head 31. When the output shaft 10 of a linear reciprocatingly movement-type driving structure moves linearly and reciprocatingly, the drawbar shaft 30 forces the brushing head 31 to swing in the axial direction. As shown in FIGS. 3 and 4, when the output shaft 10 moves forward linearly, the head 31 is driven to swing in an anticlockwise direction; as shown in FIGS. 5 and 6, when the output shaft 10 moves backward linearly, the brushing head 31 is driven to swing in a clockwise direction. Because the linear reciprocatingly movement-type driving structure and the driven part are assembled through clearance fit and move together, the collision and abrasion due to the movement could be avoided, and the service life is therefore prolonged.

The utility model also provides a cleaning tool comprising a casing, and said linear reciprocatingly movement-type driving structure is set inside said casing.

In the utility model, said housing comprises of a brushing head, while a scouring pad or hook-and-loop fastener is installed on the outside of the head.

The linear reciprocatingly movement-type driving structure and the cleaning tool according to this utility model change the driving method of the motor from a 360-degree rotation into a linear reciprocating motion through the driving gear 15, the crown gear 12, the eccentric cam 13, the first connecting shaft 14, the crankshaft 11 and the output shaft 10. Therefore the wear and tear is reduced and the service life is prolonged.

The above is only for the description of the preferred embodiments of the utility model, not for limiting the scope of the utility model. Any modifications, equivalent changes and improvements that are within the spirit and principles in the utility model should be included in the scope of protection of the utility model.

What is claimed is:

1. A linear reciprocatingly movement-type driving structure, wherein comprising of:
a driving gear (15) and a crown gear (12) engaged with said driving gear (15);
an eccentric cam (13) that is set eccentrically on the crown gear (12), a first connecting shaft (14) is set on said eccentric cam (13), a crankshaft (11) is sleeved on the first connecting shaft (14), while the crankshaft (11) is connected to an output shaft (10).

2. A linear reciprocatingly movement-type driving structure according to claim 1, wherein further comprises of: a motor (16) that causes the said driving gear (15) rotating.

3. A linear reciprocatingly movement-type driving structure according to claim 1, wherein there is a ring (111) set on the crankshaft (11), and said ring (111) is sleeved on said first connecting shaft (14).

4. A linear reciprocatingly movement-type driving structure according to claim 2, wherein said linear reciprocatingly movement-type driving structure further comprises of:
a upper casing (23) and a lower casing (24) that can be assembled together to form a housing;
the said motor (16), crown gear (13), crankshaft (11) and output shaft (10) are set inside the said housing.

5. A cleaning tool comprising a casing, wherein a linear reciprocatingly movement-type driving structure according to claim 1 is set inside said casing.

6. A cleaning tool according to claim 5, wherein said casing comprises of a brushing head, while a scouring pad or hook-and-loop fastener is installed on the exterior part of the brushing head.

7. A cleaning tool comprising a casing, wherein a linear reciprocatingly movement-type driving structure according to claim 2 is set inside said casing.

8. A cleaning tool comprising a casing, wherein a linear reciprocatingly movement-type driving structure according to claim 3 is set inside said casing.

9. A cleaning tool comprising a casing, wherein a linear reciprocatingly movement-type driving structure according to claim 4 is set inside said casing.
